(19) United States
(12) Patent Application Publication
(10) Pub. No.: US 2025/0234294 A1
(43) Pub. Date: Jul. 17, 2025

(54) METHODS, APPARATUS, AND SYSTEMS FOR LOW-COMPLEXITY AND LOW-POWER WAKE-UP OF ELECTRONIC DEVICE

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 19/055,347

(22) Filed: Feb. 17, 2025

Related U.S. Application Data
(63) Continuation of application No. PCT/CN2022/113662, filed on Aug. 19, 2022.

(51) Int. Cl. H04W 52/02

(52) U.S. Cl. CPC H04W 52/0235

(57) ABSTRACT

Systems and methods for configuring, transmitting and receiving a new chirp-based wake-up signal (WUS) are provided that enable low complexity and low power RF domain detection. With the provided system and method, a WUS is transmitted over a wireless communications channel to a target receiver or to a group of target receivers based on configuration parameters that include at least one of a starting time, a starting frequency or a chirp rate. At least one of the configuration parameters is associated with an identity of the target receiver or the group of target receivers.

### CROSS-REFERENCE TO RELATED APPLICATION

This application is a continuation of International Application No. PCT/CN2022/113662, filed on Aug. 19, 2022, the disclosure of which is hereby incorporated by reference in its entirety.

### TECHNICAL FIELD

The application relates generally to wireless communications, and more specifically to wake up signal generation, transmission and reception.

### BACKGROUND

In wireless systems, a node such as a user equipment (UE) may transition into idle or inactive mode or other power saving modes in order to reduce power consumption, for example when the node does not have data to receive from other nodes or data to send to other nodes. However, after the transition, there might be a need for the node to wake up and perform some specific procedures. The procedure in which a node is woken up is called a wake-up (WU) process. A paging procedure is an example of an application that requires such a WU process. When data arrives at the base station (BS) to be sent to a UE which in the inactive or idle mode, the BS must first wake up the UE before sending the data to the UE. In recent releases of the 3GPP standard, the paging procedure involves the BS first sending, to the UE, a WU signal (WUS) in the form of a Zadoff-Chu (ZC) sequence of length 131. If the UE detects this sequence, it then turns on its digital baseband processor to check the physical downlink control channel (PDCCH). Otherwise, the UE will keep sleeping. A significant consequence of enabling detection of a ZC-based WUS, before PDCCH monitoring, is that the UE should be equipped with a low complexity receiver for WUS detection. Evaluations have shown that to achieve a good detection performance with this scheme and particular WUS, the WUS detection should be performed in the digital domain. Unfortunately, this need for operations in the digital baseband carries a power consumption penalty. Furthermore, WUS detection performance is sensitive to impairments such as sampling time and frequency offset and synchronization errors.

### SUMMARY

Systems, apparatuses, and methods for configuring, transmitting and receiving a new chirp-based wake-up signal (WUS) are provided to enable low-complexity and low-power RF domain detection, while maintaining a good level of detection performance. With the provided system and method, a WUS is transmitted over a wireless communications channel to a target receiver or to a group of target receivers based on configuration parameters that include at least one of a starting time, a starting frequency or a chirp rate. At least one of the configuration parameters is associated with an identity of the target receiver or the group of target receivers.

The WUS may be used in a variety of nodes or links in a communication system, such as a node in an integrated access and backhaul (IAB) system, a node in a mesh network, or a side link in a system. The WUS enables RF domain detection, or detection almost entirely in the RF domain with minimal digital processing. Thus, the WUS detection may be accomplished with lower power consumption and complexity, as compared to traditional approaches, while maintaining a good level of detection performance.

According to one aspect of the present disclosure, there is provided a method. The method comprises transmitting wakeup signal configuration parameters to a target receiver or to a group of target receivers. The configuration parameters comprise at least one of a starting time, a starting frequency or a chirp rate. At least one of the configuration parameters is associated with an identity of the target receiver or the group of target receivers. The method further comprises transmitting a wakeup signal over a wireless communications channel according to the configuration parameters.

In some embodiments, the chirp rate is a rate that is common across target UEs or groups of target UEs, and the starting time and starting frequency are associated with the identity of the target receiver or group of target receivers; or the starting frequency is common across target UEs or groups of target UEs, and the starting time and chirp rate are associated with the identity of the target receiver or group of target receivers; or the starting time is common across target UEs or groups of target UEs, and the starting frequency and chirp rate are associated with the identity of the target receiver or group of target receivers; or the starting frequency and starting time are common across target UEs or groups of target UEs, and the chirp rate is associated with the identity of the target receiver or group of target receivers; or the starting frequency and chirp rate are common across target UEs or groups of target UEs, and the starting time is associated with the identity of the target receiver or group of target receivers; or the starting time and chirp rate are common across target UEs or groups of target UEs, and the starting frequency is associated with the identity of the target receiver or group of target receivers; or the starting time and starting frequency and chirp rate are associated with the identity of the target receiver or group of target receivers; or at least one of: starting time, starting frequency or chirp rate are associated with the identity of the target receiver or group of target receivers.

In some embodiments, the method further comprises: transmitting the wakeup signal as part of a paging procedure; or transmitting the wakeup signal as part of a procedure to request a sensing operation; or transmitting the wakeup signal as part of a paging procedure to request a measurement; or transmitting the wakeup signal as part of a specific non-periodic procedure.

In some embodiments, transmitting the wakeup signal comprises transmitting the wakeup signal by a network device for reception by target receiver that is a user equipment (UE) or a group of target receivers that is a group of UEs; or transmitting the wakeup signal comprises transmitting the wakeup signal by a user equipment for reception by target receiver that is another UE or a group of target receivers that is a group of UEs; or transmitting the wakeup signal comprises transmitting the wakeup signal by a network device for reception by another network device.

In some embodiments, the chirp is transmitted starting at the start time and ending after a transmission window duration, wherein the transmission window duration is based on a position of the target receiver or positions of the group of target receivers.

In some embodiments, chirp rate is associated with target receiver or group of target receivers based on priority, with better performing chirp rates assigned to higher priority target receivers or groups of target receivers.

In some embodiments, the chirp rate and/or duration of the first chirp are selected based on a capability of the target receiver or group of target receivers.

In some embodiments, transmitting the wakeup signal over the wireless communications channel comprises transmitting a plurality of chirps inclusive of said first chirp.

In some embodiments, each of the plurality of chirps has a same chirp rate for a given target receiver or group of target receivers; or the plurality of chirps collectively have multiple different chirp rates.

In some embodiments, transmitting wakeup signal configuration parameters comprises transmitting wakeup signal configuration parameters for the plurality of chirps.

In some embodiments, the chirp rate and/or the chirp duration of the plurality of chirps are selected based on a capability of the target receiver or group of target receivers.

In some embodiments, the method further comprises: transmitting at least one parameter configuring a decision rule for processing the chirp.

In some embodiments, the method further comprises: receiving an indication of detecting the wakeup signal from the target receiver or from one or more target receivers in the group of target receivers.

According to another aspect of the present disclosure, there is provided a method. The method comprises receiving wakeup signal configuration parameters for a target receiver or for a group of target receivers. The configuration parameters comprise at least one of a starting time, a starting frequency or a chirp rate. At least one of the configuration parameters is associated with an identity of the target receiver or the group of target receivers. The method further comprises receiving a wakeup signal over a wireless communications channel according to the configuration parameters.

In some embodiments, the chirp rate is a rate that is common across target UEs or groups of target UEs, and the starting time and starting frequency are associated with the identity of the target receiver or group of target receivers; or the starting frequency is common across target UEs or groups of target UEs, and the starting time and chirp rate are associated with the identity of the target receiver or group of target receivers; or the starting time is common across target UEs or groups of target UEs, and the starting frequency and chirp rate are associated with the identity of the target receiver or group of target receivers; or the starting frequency and starting time are common across target UEs or groups of target UEs, and the chirp rate is associated with the identity of the target receiver or group of target receivers; or the starting frequency and chirp rate are common across target UEs or groups of target UEs, and the starting time is associated with the identity of the target receiver or group of target receivers; or the starting time and chirp rate are common across target UEs or groups of target UEs, and the starting frequency is associated with the identity of the target receiver or group of target receivers; or the starting time and starting frequency and chirp rate are associated with the identity of the target receiver or group of target receivers; or at least one of: starting time, starting frequency or chirp rate are associated with the identity of the target receiver or group of target receivers.

In some embodiments, the method comprises: receiving the wakeup signal as part of a paging procedure; or receiving the wakeup signal as part of a procedure to request a sensing operation; or receiving the wakeup signal as part of a paging procedure to request a measurement; or receiving the wakeup signal as part of a specific non-periodic procedure.

In some embodiments, receiving the wakeup signal comprises receiving the wakeup signal by a network device for reception by target receiver that is a user equipment (UE) or a group of target receivers that is a group of UEs; or receiving the wakeup signal comprises receiving the wakeup signal by a user equipment for reception by target receiver that is another UE or a group of target receivers that is a group of UEs; or receiving the wakeup signal comprises receiving the wakeup signal by a network device for reception by another network device.

In some embodiments, the chirp is transmitted starting at the start time and ending after a transmission window duration, wherein the transmission window duration is based on a position of the target receiver or positions of the group of target receivers.

In some embodiments, chirp rate is associated with target receiver or group of target receivers based on priority, with better performing chirp rates assigned to higher priority target receivers or groups of target receivers.

In some embodiments, the chirp rate and/or transmission window duration of the first chirp are selected based on a capability of the target receiver or group of target receivers.

In some embodiments, receiving the wakeup signal over the wireless communications channel comprises receiving a plurality of chirps inclusive of said first chirp.

In some embodiments, each of the plurality of chirps has a same chirp rate for a given target receiver or group of target receivers; or the plurality of chirps collectively have multiple different chirp rates.

In some embodiments, receiving wakeup signal configuration parameters comprises receiving wakeup signal configuration parameters for the plurality of chirps.

In some embodiments, the chirp rate and/or the transmission window duration of the plurality of chirps are selected based on a capability of the target receiver or group of target receivers.

In some embodiments, the method further comprises: receiving at least one parameter configuring a decision rule for processing the chirp.

In some embodiments, the method further comprises: transmitting an indication of detecting the wakeup signal.

In some embodiments, the method further comprises: performing detection to determine whether the chirp signal is for that specific receiver; upon determining the chirp signal is for that specific receiver, waking up further circuitry in the receiver.

According to another aspect of the present disclosure, there is provided an apparatus comprising a processor configured to cause the apparatus to carry out the method as described herein.

According to another aspect of the present disclosure, there is provided a computer-readable storage medium comprising instructions which, when executed by a computer, cause the computer to carry out the method as described herein.

According to another aspect of the present disclosure, there is provided a computer program product comprising instructions which, when the program is executed by a computer, cause the computer to carry out the method as described herein.

According to another aspect of the present disclosure, there is provided a processor of an apparatus, the processor configured to cause the apparatus to carry out the method as described herein.

According to another aspect of the present disclosure, there is provided a system comprising a network device and a wireless device. The network device is configured to transmit a wakeup signal. The wakeup signal is based on configuration parameters comprising at least one of a starting time, a starting frequency, or a chirp rate. The configuration parameters are associated with an identity of a target receiver or a group of target receivers. The wireless device is configured as the target receiver or one receiver of the group of target receivers. The wireless device is further configured to receive the wakeup signal over the wireless communications channel according to the configuration parameters.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 is a flowchart of a method of WUS transmission;

FIG. 6 is a flowchart of a method of WUS reception;

FIG. 7 is an example of time-frequency resources and chirp rate mapping for WUS transmission;

FIGS. 8A and 8B are further examples of time-frequency resources and chirp rate mapping for WUS transmission;

FIG. 9 shows an example of chirp-based WUS configuration based on the UE location;

FIG. 10 shows an example of chirp-based WUS configuration based on UE capabilities;

FIG. 11 shows an example of chirp signal configuration for UE i;

FIG. 12 is a block diagram of a system for transmitting and receiving chirp-based WUS where a single chirp is transmitted to wake up a UE; and

FIG. 13 is a block diagram of a system for transmitting and receiving chirp-based WUS where multiple chirps are transmitted to wake up a UE.

### DETAILED DESCRIPTION

Systems, apparatuses, and methods for configuring, transmitting and receiving a new chirp-based WUS to enable low-complexity and low-power RF domain detection, while maintaining a good level of detection performance, are provided. In the description below, the detailed embodiments are presented in the context of UE wake up, for example as part of a paging procedure. However, applications making use of a chirp-based WUS are not only limited to paging procedure. Another example is to wake up a UE to perform a procedure such as sensing, or to perform some specific non-periodic measurement. The scope of applications of the provided WUS is not restricted to UEs. Wake up signaling can be used for other nodes and even for links. For instance, the provided WUS may be used to wake up a BS in an integrated access and backhaul (IAB) system for doing some specific procedure, to wake up a node in a mesh network, or to wake up a side link in the system.

The provided chirp-based WUS enables RF domain detection without performance loss. Therefore, a UE can detect the WUS in the RF domain (or almost entirely in the RF domain with minimal digital processing) with low power consumption and complexity while maintaining a good level of detection performance.

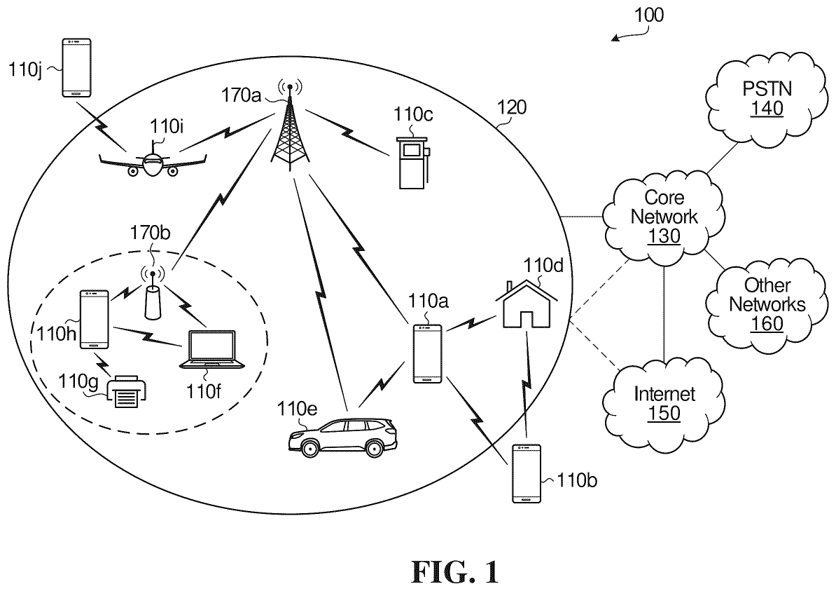

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

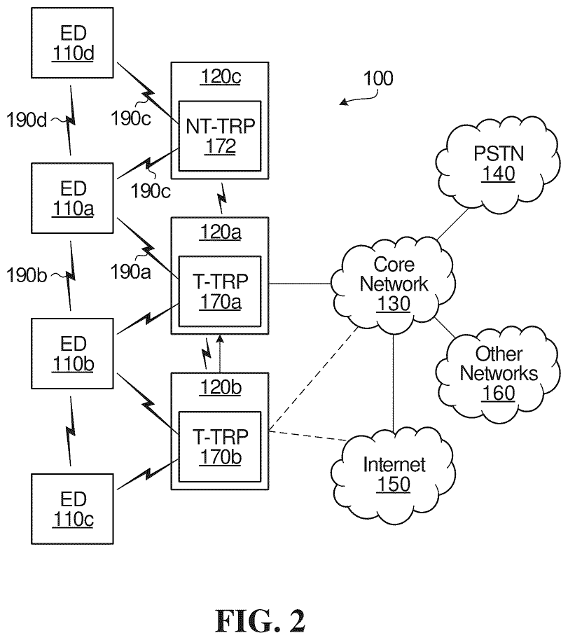

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. T he non-terrestrial communication network 120c includes an access node which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

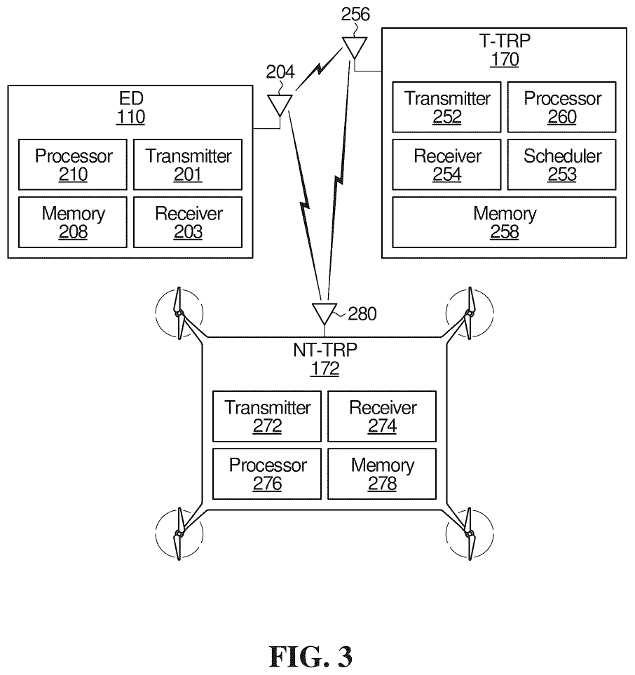

FIG. 3 illustrates another example of an ED 110 and a base station 170a and/or 170b. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

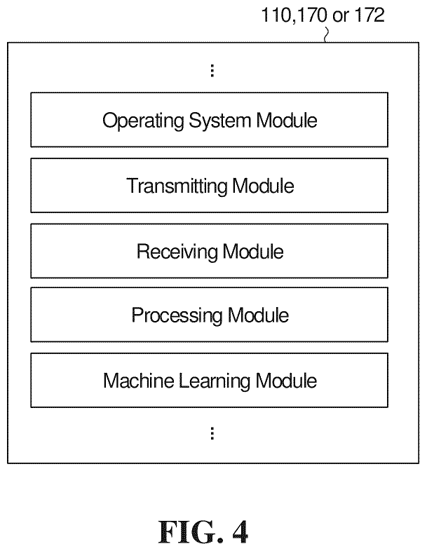

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

A new chirp-based WUS design is provided. A chirp is a signal whose frequency is linearly increasing in time with a slope called a chirp rate. As a result, if the network wants to wake up a UE, the network (e.g. a base station) sends one or multiple chirp signals in dedicated time-frequency resources assigned to that UE or group of UEs. The UE also monitors its dedicated time-frequency resources to see if a chirp or chirps corresponding to that UE are sent. This operation can be done in RF analog domain. If the UE detects its corresponding chirp signal(s), it wakes up, turns on its digital baseband processor, and follows the instructions sent through the control channels in the digital baseband domain.

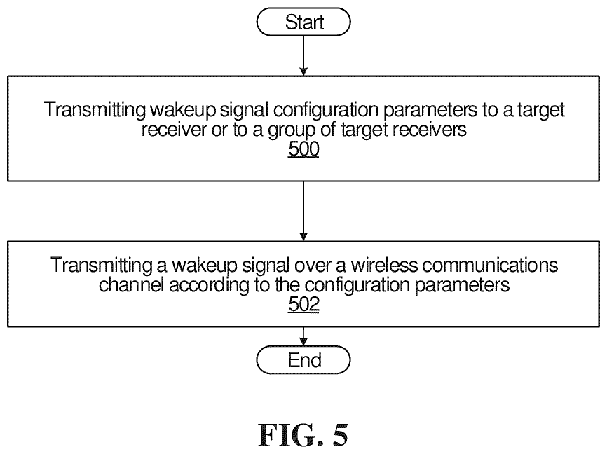

Referring now to FIG. 5, shown is a flowchart of configuring and then transmitting a chirp-based WUS. The method begins in block 500 with transmitting wakeup signal configuration parameters to a target receiver or to a group of target receivers. In some embodiments, the configuration parameters comprise at least one of a starting time, a starting frequency or a chirp rate. In some embodiments, at least one of the configuration parameters is associated with an identity of the target receiver or the group of target receivers. The method continues in block 502 with transmitting a wakeup signal over a wireless communications channel according to the configuration parameters.

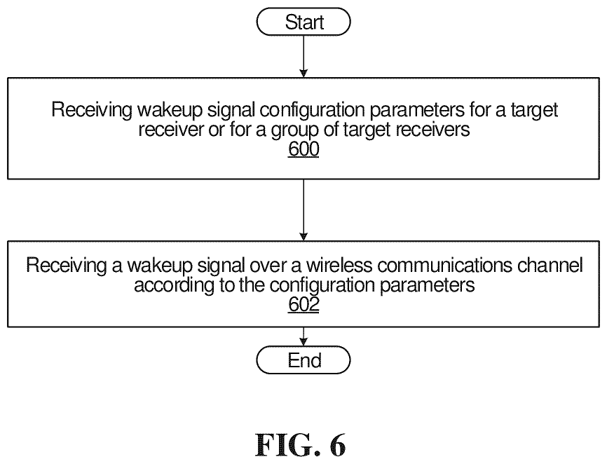

Referring now to FIG. 6, shown is a flowchart of a method of receiving a configuration and then receiving a chirp-based WUS. The method begins in block 600 with receiving wakeup signal configuration parameters for a target receiver or for a group of target receivers. In some embodiments, the configuration parameters comprise at least one of a starting time, a starting frequency or a chirp rate. In some embodiments, at least one of the configuration parameters is associated with an identity of the target receiver or the group of target receivers. The method continues in block 602 with receiving a wakeup signal over a wireless communications channel according to the configuration parameters.

Advantageously, in the receiver, the WUS can be processed mainly in the RF analog domain, leading to lower power consumption compared to the use of a full-featured baseband processor. WUS generation and detection can be implemented with low complexity. Detailed examples are provided below. In some embodiments, the WUS can be configured based on UE capability and/or location. Advantageously, high reliability can be achieved with the provided WUS, with low WUS misdetection and false alarm probabilities. The provided approach also has the potential to multiplex many UEs efficiently, i.e. to be able to multiplex many UEs with a low number of time-frequency resources. Detailed examples are provided below.

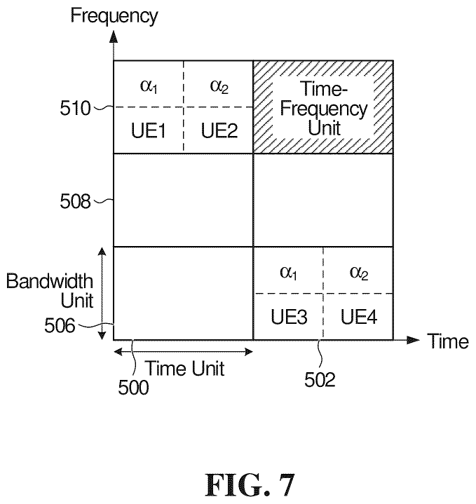

In some embodiments, a UE specific three-dimensional (3D) parameter configuration for mapping UE ID or UE group ID in three dimensions including time, frequency, and chirp rate is employed. One example of such mapping is shown in FIG. 7. Time-frequency resources have a frequency dimension and a time dimension. In the example of FIG. 7, there are two possible time units 500, 502, and three possible bandwidth units 506, 508, 510, yielding a total of 6 possible distinct time-frequency resources. Another parameter is α, which is the chirp rate. In the illustrated examples, for WUS purposes, UE1, UE2, UE3 and UE4 are multiplexed in time, frequency and chirp rate domains. Specifically, UE1 is mapped to time unit 500, bandwidth unit 510, and chirp rate α₁. UE2 is mapped to time unit 500, bandwidth unit 510, and chirp rate α₂. UE3 is mapped to time unit 502, bandwidth unit 506, and chirp rate α₁. UE4 is mapped to time unit 502, bandwidth unit 506, and chirp rate α₂. UEs mapped to the same time and bandwidth units are separated in the chirp rate domain. In this case, groups of UEs are assigned to a given chirp rate, but different time-frequency resources. In FIG. 7, there are two groups. Group 1 includes UE1 and UE3. Chirp rate α₁ is assigned to this group. Group 2 includes UE2 and UE4, to which is assigned chirp rate α₂. UE1 and UE2 (one from each group) are assigned the same time-frequency unit. Similarly, UE3 and UE4 are assigned the same time-frequency unit. Equivalently, UEs can be grouped and each group can be assigned one or multiple time-frequency units. Within each group, the UEs are distributed in the chirp rate domain.

In some embodiments, the chirp rate is a rate that is common across target UEs or groups of target UEs, and the starting time and starting frequency are associated with the identity of the target receiver or group of target receivers.

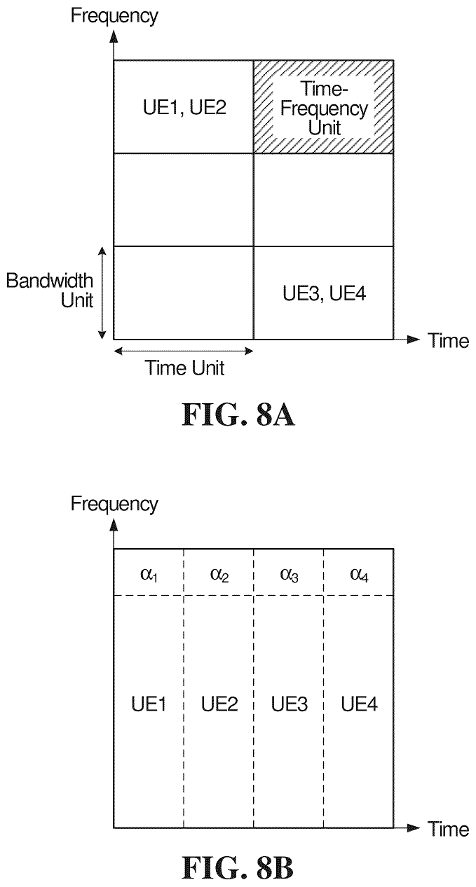

An example is shown in FIG. 8A, where a common chirp rate a is assigned to all UEs and the UEs are only multiplexed in the time-frequency domain. As such, the chirp is the same for all the UEs which are assigned the same time-frequency resources. For this case, the control signaling and perhaps the implementation complexity are lower than the general case (with more than one available chirp rate), and the chirp rate domain is not used for multiplexing UEs. Therefore, for the same level of false alarm wake up, this type of mapping accommodates fewer UEs in the same time-frequency unit.

In some embodiments, the starting frequency is common across target UEs or groups of target UEs, and the starting time and chirp rate are associated with the identity of the target receiver or group of target receivers.

In some embodiments, the starting time is common across target UEs or groups of target UEs, and the starting frequency and chirp rate are associated with the identity of the target receiver or group of target receivers.

In some embodiments, the starting frequency and starting time are common across target UEs or groups of target UEs, and the chirp rate is associated with the identity of the target receiver or group of target receivers.

An example is shown in FIG. 8B, which shows a set of UEs that are only separated in the chirp rate domain; all of the UEs are assigned the same time-frequency resources. This may allow a larger time-frequency resource for every UE but the resource is reused for all UEs.

In some embodiments, the starting frequency and chirp rate are common across target UEs or groups of target UEs, and the starting time is associated with the identity of the target receiver or group of target receivers.

In some embodiments, the starting time and chirp rate are common across target UEs or groups of target UEs, and the starting frequency is associated with the identity of the target receiver or group of target receivers.

In some embodiments, the starting time and starting frequency and chirp rate are associated with the identity of the target receiver or group of target receivers.

Note that the choice of scale for the time unit and bandwidth unit may be selected and/or configured by the network. Some examples of the time-frequency unit are resource element (RE), resource element group (REG), resource block (RB), and resource block group (RBG).

In some embodiments, the WUS configured and transmitted to a given UE can have a single chirp or multiple chirps per UE and in the case of having multiple chirps per UE, the chirp rates can be the same or different for each chirp per UE. This configuration provides a good foundation for multiplexing a large number of UEs in the chirp rate domain. In this embodiment, the UE mapping to WUS resources can also be based on the chirp rate or chirp rates assigned to UEs. This allows for additional multiplexing in the chirp rate domain. Additionally, having multiple chirps can help to improve the reliability by providing diversity in the detection.

### Detailed Example Mapping for WUS Including a Single Chirp

Let [symbol] be a set of UE IDs. Denote the duration of a time unit by δₜ and the width in frequency of a bandwidth unit by δ_{f}. The choices of time and bandwidth units may be made by the network. In this particular example, the starting point of the chirp signal in the time domain is a multiple of the time unit. Define [symbol] ₜ={n₁ δ₁, n₂δₜ, . . . , n₁, δₜ} to be the set of possible starting point of the chirp signal in the time domain for a UE, where nₖ∈ [symbol] ∪{0}, and Lₜ is the cardinality of set [symbol] ₜ. The choice of set [symbol] ₜ is up to the network. Similarly, in this particular example, the starting point of the chirp signal in the frequency domain is a multiple of the bandwidth unit. Define [symbol] _{f}={m₁δ_{f}, m₂δ_{f}, . . . , m_{L}_{_{f}}, δ_{f}} to be the set of possible starting points of the chirp signal in the frequency domain for a UE, where mₖ∈ [symbol] ∪{0}, and L_{f} is the cardinality of set [symbol] _{f}. The choice of set [symbol] _{f} is up to the network. For this example, the transmission window duration (the length of time over which the chirp WUS is transmitted) is a multiple of time unit δₜ. Let [symbol] _{T}={l₁δₜ, l₂δₜ, . . . , l_{L}_{_{T}}δₜ} denote the set of possible transmission window durations for a UE where lₖ∈ [symbol] ∪{0}, and L_{T} is the cardinality of set [symbol] _{T}. Finally, let [symbol] _{α}={q₁, q₂, . . . , q_{L}_{_{c}}} denote the set of all available chirp rates that can be assigned to a UE. The following mappings are defined:
1) tᵢ=Fₜ(IDᵢ), Fₜ: [symbol] → [symbol] t,
2) fᵢ=F_{f}(IDᵢ), F_{f}: [symbol] → [symbol] f,
3) Tᵢ=F_{T}(IDᵢ), F_{T}: [symbol] → [symbol] T,
4) αᵢ=F_{α}(IDᵢ), F_{α}: [symbol] → [symbol] _{α}, where IDᵢ is the ID of UE i. The first two mappings provide the starting point of the chirp assigned to UE i in the time and frequency domains, denoted by tᵢ and fᵢ, respectively. The third mapping gives the transmission window duration for UE i, denoted by Tᵢ. The last mapping, provides the chirp rate assigned to UE i denoted by α₁. These mappings take as input the ID of UE i and map it to the time-frequency resources of the chirp signal used for UE i as well as the chirp rate. FIG. 11 shows an example of a chirp signal configured for a UE or group of UEs. Note that the defined mapping does not have to be one-to-one; the same parameters can be assigned to multiple UEs.

It is noted that generally a transmission window and measurement window can be different. The transmission window is related to the transmitter (e.g. TRP) and the measurement window is related to the receiver (e.g. UE). While these two parameters can be the same, it is not necessary. For example, there could be a scenario with one TRP and two UEs. The TRP can send the WUS with transmission window T while UE1 and UE2 can use measurement windows L₁ and L₂, respectively. T, L₁, and L₂ can generally be different. Normally, the measurement window is a subset of the transmission window which implies that L₁, L₂≤T. Furthermore L₁ and L₂ can potentially be optimized based on the UE positions or other features. Generally, one or both of the transmission window and measurement window can be part of WUS configuration.

Note that the mappings together, implicitly provide the time frequency resource units allocated to UE i. To elaborate, if the starting point of the chirp in time and frequency is known along with the transmission window duration and the chirp rate, the time-frequency resource units occupied by the resulting chirp can be determined. Conversely, if the time-frequency resources occupied by the chirp as well as the chirp rate is known, then the starting point of the chirp and transmission window duration are also uniquely determined. In conclusion, knowing the starting point of the chirp, transmission window duration, and chirp rate is equivalent to knowing time-frequency resource units used by chirp and the chirp rate.

The mappings can be in the form of look-up tables or formulas. These mappings are functions of UE ID or UE group ID. The parameters can be computed by the network using the defined formulas or look-up tables and signaled to the UE(s). In this case for example, radio resource control (RRC) configuration signaling can be used to send the configuration parameters to the UE(s). In some embodiments, this signaling is performed before the UE transitions to a reduced power mode. Alternatively, the formulas or look-up tables are sent to the UE(s). The UE(s) can then substitute its ID (or group ID) in the formula to determine its WUS configuration or can use the ID to look up the WUS configuration in a look-up table.

Given the mappings, the following steps are taken at the BS if UE i is to be woken up:
1) The BS generates a chirp with the chirp rate αᵢ.
2) The BS transmits the chirp in the time-frequency resources assigned to UE (which is implied by the choice of αᵢ, tᵢ, fᵢ, and Tᵢ).
3) The UE receives the signal and decides on the presence of the chirp. If the chirp is detected, the UE wakes up. This step may be performed in the analog RF domain (e.g. via matched filtering) to exploit low-complexity operations and low power consumption.

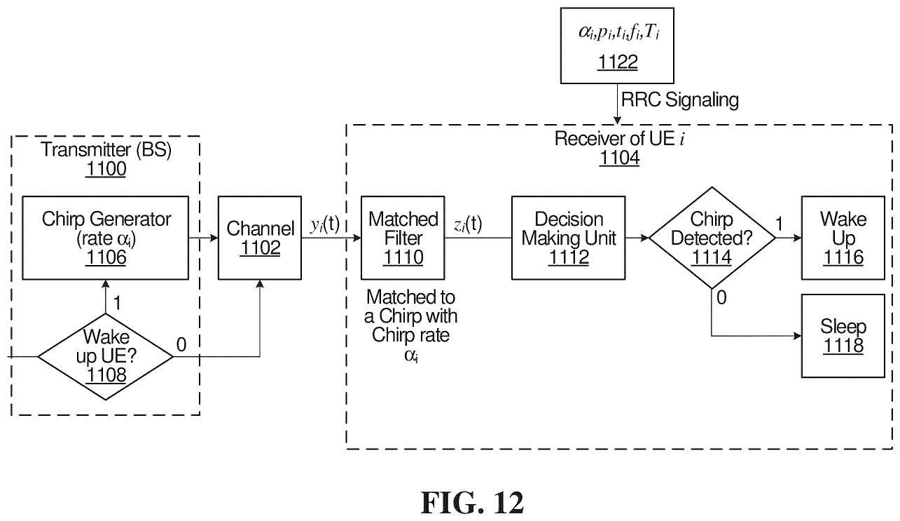

FIG. 12 below shows an example system operation diagram using the provided single chirp-based WU signaling with one possible option for the WUS receiver based on matched filtering. Shown is a transmitter 1100 (which may be a BS but is not necessarily so), and a receiver 1102 (assumed to be a receiver of a UE i, but not necessarily so). Also shown is channel 1102.

On the transmit side, if UE i is to be woken up (output of decision making unit 1108 is 1), the transmitter 1100 generates a chirp with chirp rate αᵢ and transmits it in the time-frequency resources assigned to WUS of UE i. If the UE i is not to be woken up (output of decision making unit 1108 is 0), then no chirp signal is generated and transmitted.

On the receive side, the receiver 1104 has a matched filter 1110 matched to the chirp with chirp rate αᵢ. An output of the matched filter 1110 is processed by a decision making unit 1112 to produce a decision as to whether a chirp with chirp rate αᵢ has been sent or not. If yes (yes path block 1114), the UE wakes up as indicated at 1116 and otherwise (no path block 1114) it will keep sleeping as indicated at 1118. The input of the decision making unit 1112 is a continuous time signal zᵢ(t) and its output is binary (1 if wakeup chirp signal is detected and 0, otherwise). Regarding the decision making unit 1112, in some embodiments, statistical hypothesis testing is used to map the continuous input to the discrete binary decision. In a specific example, the decision under hypothesis testing involves estimating the signal power (for example by a signal envelope detector) and comparing the signal power with a predefined threshold ρᵢ. Note that this is a relatively low-complexity operation. The threshold ρᵢ determines the probability of misdetection and false alarm, and the threshold can be set by the network for the UE. Additionally, this threshold can be sent to the UE by the network using, for example, RRC configuration signaling before the UE enters low power mode (e.g. inactive or idle mode). More generally, a complete set of configuration parameters are shown at 1122 transmitted and received via RRC signaling.

In some embodiments, the decision making unit 1112 includes an analog to digital convertor (ADC) with low sampling rate to take samples of analog signal zᵢ(t) first, and then make a decision based on the samples. The ADC with low sampling rate may be separate or functionally distinct from a conventional ADC typically used for full-featured baseband processing. Alternatively, the ADC with low sampling rate may be a same ADC used for baseband full-featured baseband processing, but simply configured low power consumption and limited baseband processing functionality. Thus, even in embodiments where the WU decision includes some digital baseband processing, the WU decision may still consume relatively less power than traditional WU approaches.

The matched filter can be implemented using RF-based processing, which procedure reduces the power consumption compared to using conventional baseband processing for WUS detection. In addition, the WUS detection can be accomplished with low complexity operations that can be implemented using simple circuitry rather than activating a full baseband processor. In some embodiments, a separate (from the baseband processor) digital circuit is provided that processes the output of the RF-based processing and makes a WU decision.

### Detailed Example Mapping for WUS Including Multiple Chirps

In this detailed example, the WUS of a UE includes multiple chirp signals. Instead of sending a single chirp signal to UE i, Nᵢ chirps are sent. The UE decides to wake up based on detection of the Nᵢ chirps, for example, if the UE can detect at least Mᵢ chirps out of those Nᵢ chirps that are sent. This approach provides diversity which can improve the reliability of the UE decision to wake up or not. In some embodiments, Nᵢ and Mᵢ can be selected for UE i based on its capabilities and/or location, to reduce the probability of misdetection and false alarm. A detailed example is provided below. Note that in this case, UE i can be assigned up to Nᵢ chirp rates (one for each chirp) and generally the chirp rates can be different. One special case is to use the same chirp rate for all Nᵢ chirps of UE i. Furthermore, the chirps corresponding to a UE can be multiplexed only in time, only in frequency, or in both time and frequency domains. Therefore, in the general case, one set of the parameters that would be defined for the single chirp case (i.e., starting point in time, starting point in frequency, transmission window duration, and chirp rate) are defined for each chirp of UE i. Consequently, for each parameter, the corresponding mapping generates Nᵢ values for UE i. Let t_{i,j}, f_{i,j}, T_{i,j}, and α_{i,j} be the parameters corresponding to the j^{th} chirp of UE i.

Given the parameters, the following steps are taken at the BS if UE i is to be woken up:
1) The BS generates Nᵢ chirp signals where the slope of j^{th} chirp is a_{i,j}.
2) The BS transmits each of the Nᵢ chirps in the time-frequency resources assigned to that chirp for UE i.

3) The UE receives the signals and decides on the presence of each chirp signal. If at least Mᵢ chirp signals are detected, the UE wakes up. It is preferable to perform this step in the analog RF domain (e.g. via matched filtering) to exploit low-complexity operations and low power consumption.

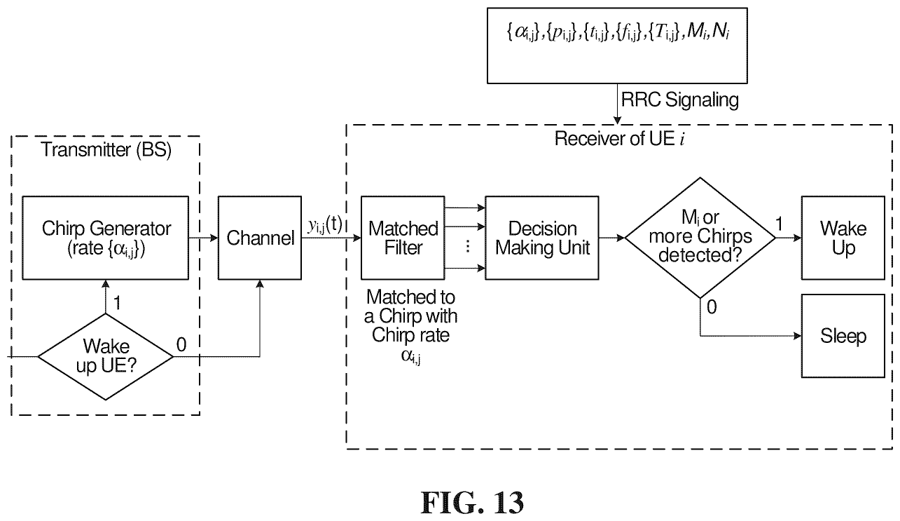

A transmitter and receiver structure similar to those described with reference to FIG. 12 for the case with a single chirp per UE may be employed. FIG. 13 depicts a system diagram for a case in which multiple chirp signals are used per UE. This system diagram shows an example of a receiver architecture for WUS detection based on matched filtering. The UE can have one matched filter per chirp or one or multiple tunable matched filters. The decision making unit receives an output of the matched filter(s) and makes a decision per chirp, deciding if it is present or not. In this example, the UE uses a threshold for each chirp. Define ρ_{i,j} as the threshold for the j^{th} chirp of UE i. The thresholds can be different if the chirp rates are different. UE i should know (for example through previous RRC signaling) Nᵢ, Mᵢ, {ρ_{i,j}}, and the parameters of each chirp assigned to the UE.

This example involves the use of multiple chirps per UE, can provide diversity and improve the WU detection performance at the UE. Furthermore, using multiple chirp signals per UE expands the dimension of the chirp rate domain. This in turn enables multiplexing more UEs in the chirp rate domain while using the same time-frequency resources.

### Mappings Based on Position and/or Priority

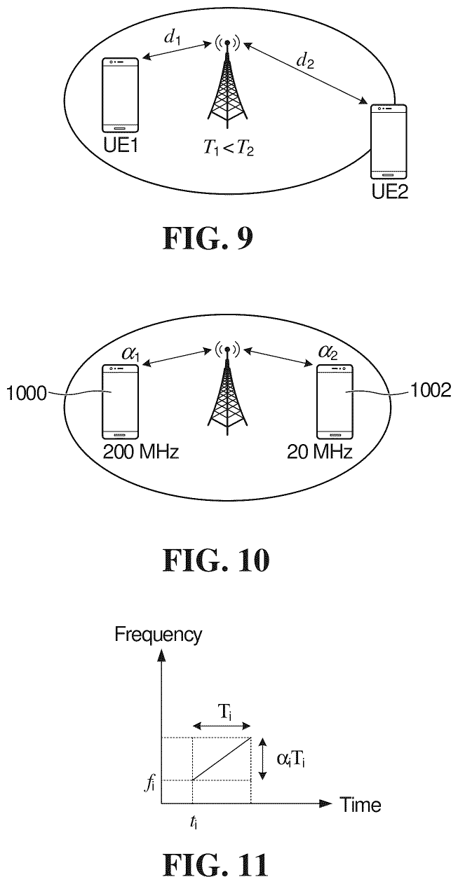

In some embodiments, the chirp configuration is based on UE position. In some embodiments, the transmission window duration for a UE is based on its location with respect to the BS. A UE that is further from the BS will experience a lower signal to noise ratio (SNR) due to larger path loss and this deteriorates the WUS detection performance. A longer transmission window can be used to provide a processing gain which compensates at least in part for the larger path loss for such a UE. FIG. 9 shows an example where UE2 is further from the BS than UE1. Therefore, UE2 has a lower SNR, and UE2 can be configured with a longer transmission window compared to that of UE1 to improve the detection performance. Rough or precise knowledge of the position of the UEs can be utilized to determine transmission window duration for the chirp-based WUS configuration. In some embodiments, a position-based transmission window duration determination is used for other wakeup signals (including for example fully digital sequences like ZC sequence currently proposed in recent releases of NR), in which the longer sequence length can be used for UEs that are farther from the base station.

More generally, a transmission window duration Tᵢ can be adjusted/selected for UE i. When using a chirp signal, after a pulse compression operation at the receiver (which is typically implemented by matched filtering), there is a processing gain that is a function of BT, where B is the chirp bandwidth and T is the transmission window duration. Therefore, the post-processing SNR is equal to pre-processing SNR multiplied by BT. To compensate the impact of path loss for the UEs far from the BS, the transmission window duration can be increased which improves the detection performance. In this embodiment, the mappings will map the combination of UE ID as well as UE location to the time-frequency resources and chirp rate. This approach can be applied in the context of single chirp per UE or in the context of multiple chirps per UE.

In some embodiments, chirp rate is used to provide differentiated performance between different UEs, for example based on UE priority. Applicant has observed that the WUS detection performance in terms of probability of misdetection and false alarm depends on the chirp rate assigned to a UE. The chirp bandwidth is given by B=α×T where B is the bandwidth, T is the transmission window duration (time duration of the chirp signal) and a is the chirp rate. Given a fixed transmission window duration, the larger the chirp rate, the larger the bandwidth, and the better the performance. For a multi-chirp scenario, the same relation holds for each chirp, i.e. B=α×T where T is the duration of each chirp and B is the bandwidth of that chirp signal.

Therefore, among the set of available chirp rates, some are better-performing than others. This can be taken into account in the chirp rate mappings. UEs can be sorted in terms of priority and better performing chirp rates can be assigned to UEs with higher priorities. For instance, misdetection can be very important for a particular UE. That UE can be assigned a chirp rate which performs better than others.

In some embodiments, chirp rate can be configured among different UE based on UE capabilities. An example is shown in FIG. 10 below which shows two UEs 1000, 1002 with different capabilities in terms of supported bandwidth. In this example, one UE 1002 can support 200 MHz bandwidth and the other UE 1000 can only support 20 MHz. A first chirp rate α1 is configured for UE 1000 that is suitable for 200 MHz bandwidth. A second chirp rate α2 is configured for UE 1002 that is suitable for 20 MHz bandwidth. If the supportable UE BW is larger, a larger chirp rate can be chosen so that the bandwidth occupied by the chirp WUS is equal to the supportable UE BW. More generally, by tuning the chirp rate, one can tune the BW occupied by the chirp WUS.

Numerous modifications and variations of the present disclosure are possible in light of the above teachings. It is therefore to be understood that within the scope of the appended claims, the disclosure may be practiced otherwise than as specifically described herein.

1. A method comprising:
transmitting wakeup signal configuration parameters to a target receiver or to a group of target receivers, wherein the wakeup signal configuration parameters indicate at least one of a starting time, a starting frequency, or a chirp rate, and wherein at least one of the wakeup signal configuration parameters is associated with an identity of the target receiver or the group of target receivers; and
transmitting a wakeup signal over a wireless communications channel according to the wakeup signal configuration parameters.

2. The method of claim 1, wherein:
the chirp rate is common across target user equipments (UEs) or groups of target UEs, and the starting time and the starting frequency are associated with the identity of the target receiver or the group of target receivers; or
the starting frequency is common across target UEs or groups of target UEs, and the starting time and the chirp rate are associated with the identity of the target receiver or the group of target receivers; or
the starting time is common across target UEs or groups of target UEs, and the starting frequency and the chirp rate are associated with the identity of the target receiver or the group of target receivers; or
the starting frequency and the starting time are common across target UEs or groups of target UEs, and the chirp rate is associated with the identity of the target receiver or the group of target receivers; or
the starting frequency and the chirp rate are common across target UEs or groups of target UEs, and the starting time is associated with the identity of the target receiver or the group of target receivers; or
the starting time and the chirp rate are common across target UEs or groups of target UEs, and the starting frequency is associated with the identity of the target receiver or the group of target receivers; or
the starting time, the starting frequency, and the chirp rate are associated with the identity of the target receiver or the group of target receivers; or
at least one of: the starting time, the starting frequency, or the chirp rate is associated with the identity of the target receiver or the group of target receivers.

3. The method of claim 1, the transmitting the wakeup signal comprising:
transmitting the wakeup signal as part of a paging procedure; or
transmitting the wakeup signal as part of a procedure to request a sensing operation; or
transmitting the wakeup signal as part of a paging procedure to request a measurement; or
transmitting the wakeup signal as part of a specific non-periodic procedure.

4. The method of claim 1, wherein the transmitting the wakeup signal comprises:
transmitting the wakeup signal by a network device for reception by the target receiver that is a UE or the group of target receivers that is a group of UEs; or
transmitting the wakeup signal by a UE for reception by the target receiver that is another UE or the group of target receivers that is a group of UEs; or
transmitting the wakeup signal by a network device for reception by another network device.

5. The method of claim 1, wherein the wakeup signal is transmitted starting at the starting time and ending after a transmission window duration, and wherein the transmission window duration is based on a position of the target receiver or positions of the group of target receivers.

6. A method comprising:
receiving wakeup signal configuration parameters for a target receiver or for a group of target receivers, wherein the wakeup signal configuration parameters indicate at least one of a starting time, a starting frequency, or a chirp rate, and wherein at least one of the wakeup signal configuration parameters is associated with an identity of the target receiver or the group of target receivers; and
receiving a wakeup signal over a wireless communications channel according to the wakeup signal configuration parameters.

7. The method of claim 6, wherein:
the chirp rate is common across target user equipments (UEs) or groups of target UEs, and the starting time and the starting frequency are associated with the identity of the target receiver or the group of target receivers; or
the starting frequency is common across target UEs or groups of target UEs, and the starting time and the chirp rate are associated with the identity of the target receiver or the group of target receivers; or
the starting time is common across target UEs or groups of target UEs, and the starting frequency and the chirp rate are associated with the identity of the target receiver or the group of target receivers; or
the starting frequency and the starting time are common across target UEs or groups of target UEs, and the chirp rate is associated with the identity of the target receiver or the group of target receivers; or
the starting frequency and the chirp rate are common across target UEs or groups of target UEs, and the starting time is associated with the identity of the target receiver or the group of target receivers; or
the starting time and the chirp rate are common across target UEs or groups of target UEs, and the starting frequency is associated with the identity of the target receiver or the group of target receivers; or
the starting time, the starting frequency, and the chirp rate are associated with the identity of the target receiver or the group of target receivers; or
at least one of: the starting time, the starting frequency, or the chirp rate is associated with the identity of the target receiver or the group of target receivers.

8. The method of claim 6, the receiving the wakeup signal comprising:
receiving the wakeup signal as part of a paging procedure; or
receiving the wakeup signal as part of a procedure to request a sensing operation; or
receiving the wakeup signal as part of a paging procedure to request a measurement; or
receiving the wakeup signal as part of a specific non-periodic procedure.

9. The method of claim 6, wherein the wakeup signal is transmitted starting at the starting time and ending after a transmission window duration, and wherein the transmission window duration is based on a position of the target receiver or positions of the group of target receivers.

10. The method of claim 6, further comprising:
performing detection to determine whether the wakeup signal is for a specific receiver; and
upon determining the wakeup signal is for the specific receiver, activating further circuitry in the specific receiver.

11. An apparatus comprising:
a memory storing instructions; and
at least one processor caused, by executing the instructions, to cause the apparatus to perform operations including:
transmitting wakeup signal configuration parameters to a target receiver or to a group of target receivers, wherein the wakeup signal configuration parameters indicate at least one of a starting time, a starting frequency, or a chirp rate, and wherein at least one of the wakeup signal configuration parameters is associated with an identity of the target receiver or the group of target receivers; and
transmitting a wakeup signal over a wireless communications channel according to the wakeup signal configuration parameters.

12. The apparatus of claim 11, wherein:
the chirp rate is common across target user equipments (UEs) or groups of target UEs, and the starting time and the starting frequency are associated with the identity of the target receiver or the group of target receivers; or
the starting frequency is common across target UEs or groups of target UEs, and the starting time and the chirp rate are associated with the identity of the target receiver or the group of target receivers; or
the starting time is common across target UEs or groups of target UEs, and the starting frequency and the chirp rate are associated with the identity of the target receiver or group of target receivers; or
the starting frequency and the starting time are common across target UEs or groups of target UEs, and the chirp rate is associated with the identity of the target receiver or the group of target receivers; or
the starting frequency and the chirp rate are common across target UEs or groups of target UEs, and the starting time is associated with the identity of the target receiver or the group of target receivers; or
the starting time and the chirp rate are common across target UEs or groups of target UEs, and the starting frequency is associated with the identity of the target receiver or the group of target receivers; or
the starting time, the starting frequency, and the chirp rate are associated with the identity of the target receiver or the group of target receivers; or
at least one of: the starting time, the starting frequency or the chirp rate is associated with the identity of the target receiver or the group of target receivers.

13. The apparatus of claim 11, the transmitting the wakeup signal comprising:
transmitting the wakeup signal as part of a paging procedure; or
transmitting the wakeup signal as part of a procedure to request a sensing operation; or
transmitting the wakeup signal as part of a paging procedure to request a measurement; or
transmitting the wakeup signal as part of a specific non-periodic procedure.

14. The apparatus of claim 11, wherein the transmitting the wakeup signal comprises:
transmitting the wakeup signal by a network device for reception by the target receiver that is a UE or the group of target receivers that is a group of UEs; or
transmitting the wakeup signal by a UE for reception by the target receiver that is another UE or the group of target receivers that is a group of UEs; or
transmitting the wakeup signal by a network device for reception by another network device.

15. The apparatus of claim 11, wherein the wakeup signal is transmitted starting at the starting time and ending after a transmission window duration, and wherein the transmission window duration is based on a position of the target receiver or positions of the group of target receivers.

16. An apparatus comprising:
a memory storing instructions; and
at least one processor caused, by executing the instructions, to cause the apparatus to perform operations including:
receiving wakeup signal configuration parameters for a target receiver or for a group of target receivers, wherein the wakeup signal configuration parameters indicate at least one of a starting time, a starting frequency, or a chirp rate, and wherein at least one of the wakeup signal configuration parameters is associated with an identity of the target receiver or the group of target receivers; and
receiving a wakeup signal over a wireless communications channel according to the wakeup signal configuration parameters.

17. The apparatus of claim 16, wherein:
the chirp rate is common across target user equipments (UEs) or groups of target UEs, and the starting time and the starting frequency are associated with the identity of the target receiver or the group of target receivers; or
the starting frequency is common across target UEs or groups of target UEs, and the starting time and the chirp rate are associated with the identity of the target receiver or the group of target receivers; or
the starting time is common across target UEs or groups of target UEs, and the starting frequency and the chirp rate are associated with the identity of the target receiver or the group of target receivers; or
the starting frequency and the starting time are common across target UEs or groups of target UEs, and the chirp rate is associated with the identity of the target receiver or the group of target receivers; or
the starting frequency and the chirp rate are common across target UEs or groups of target UEs, and the starting time is associated with the identity of the target receiver or the group of target receivers; or
the starting time and the chirp rate are common across target UEs or groups of target UEs, and the starting frequency is associated with the identity of the target receiver or the group of target receivers; or
the starting time, the starting frequency, and the chirp rate are associated with the identity of the target receiver or the group of target receivers; or
at least one of: the starting time, the starting frequency, or the chirp rate is associated with the identity of the target receiver or the group of target receivers.

18. The apparatus of claim 16, the receiving the wakeup signal comprising:
receiving the wakeup signal as part of a paging procedure; or
receiving the wakeup signal as part of a procedure to request a sensing operation; or
receiving the wakeup signal as part of a paging procedure to request a measurement; or
receiving the wakeup signal as part of a specific non-periodic procedure.

19. The apparatus of claim 16, wherein the wakeup signal is transmitted starting at the starting time and ending after a transmission window duration, and wherein the transmission window duration is based on a position of the target receiver or positions of the group of target receivers.

20. The apparatus of claim 16, the operations further comprising:
performing detection to determine whether the wakeup signal is for the apparatus; and
upon determining the wakeup signal is for the apparatus, activating further circuitry in the apparatus.
